(19) United States
(12) Patent Application Publication
(10) Pub. No.: US 2007/0061790 A1
(43) Pub. Date: Mar. 15, 2007

(54) Partially compiled data security software

(76) Inventors: Steeve Kay, Newport Coast, CA (US); Wei-Qiang Sun, Rowland Heights, CA (US)

Correspondence Address: MCDERMOTT WILL & EMERY LLP, 18191 VON KARMAN AVE., SUITE 500, IRVINE, CA, 92612-7108, US

(21) Appl. No.: 11/225,468

(22) Filed: Sep. 13, 2005

(51) Int. Cl. G06F 9/45

(52) U.S. Cl. 717/145; 717/148

(57) ABSTRACT

Described are methods of compiling computer code using a unique identifier. According to some methods, computer code is provided having a first portion that is compiled and a second portion that is uncompiled. A program is executed that seeks a unique identifier, and, if the unique identifier is present, facilitates a process that results in compilation of the second portion of the code, said compilation resulting in the unique identifier or an indicator of the unique identifier being incorporated into the compiled second portion of the code.

### BACKGROUND OF THE INVENTION

1. Field of the Invention

This invention relates to data security and encryption software and hardware and, more particularly, to instructions that protect data according to a user's entry of a unique identifier.

2. Description of the Related Art

Computers are widely interconnected and are heavily relied upon to process and store sensitive information. The risk of unauthorized access to computers and their stored information has increased with this increased interconnectivity. As a result, access is often restricted by the use of passwords and other unique identifiers that may be used to encrypt data or otherwise deny non-users' access. Passwords, user identifications, credit-card numbers and expiration dates, bank account numbers and PINs, smart-card data, biometric information (e.g., the data comprising a retina or fingerprint scan), cryptographic keys, and the like, are all examples of such unique identifiers.

Unfortunately, there are many computer users that would still attempt to overcome the cryptographic protection afforded by conventional means of protecting sensitive data. Illicit access may be obtained in a number of ways. Often, a potential data thief may exploit security flaws found in data security or other computer software, and may thereby access sensitive data stored on that computer. However, even if the computer software and system are relatively secure, the original programmer of data security software will often have critical insight into the location and storage method of any associated unique identifiers. Applying this knowledge, the original programmer or others who understand the program's methods for storing unique identifiers may be able to more easily access and decode the user's unique identifier, and thereby access the protected data. For example, even if the programmer does not know a particular user's password, the programmer may know that the password is stored in a hidden text file on the user's computer in a particular encrypted format. The programmer might then access the text file and decrypt the password.

### SUMMARY OF THE INVENTION

Accordingly, there is a need for data security software that stores a unique identifier entered by a user in such a way that the original programmer of the software cannot access that unique identifier.

According to one embodiment of the invention, a method of compiling computer code using a unique identifier is described. According to this method, computer code is provided having a first portion that is compiled and a second portion that is uncompiled. A program is also executed that seeks a unique identifier, and, if the unique identifier is present, facilitates a process that results in compilation of the second portion of the code, said compilation resulting in the unique identifier or an indicator of the unique identifier being incorporated into the compiled second portion of the code.

According to another embodiment of the invention, a method of compiling computer code using a plurality of unique identifiers is described. According to this method, computer code is provided having a first portion that is compiled and a second portion that is uncompiled. A program is also executed that seeks the plurality of unique identifiers, and, if each of the plurality of unique identifiers is present, facilitates a process that results in compilation of the second portion of the code, said compilation resulting in the plurality of unique identifiers or a plurality of respective indicators of the plurality of unique identifiers being incorporated into the compiled second portion of the code.

According to another embodiment of the invention, a computer system is provided. The computer system comprises an input device and a computer-readable medium. The computer-readable medium has stored thereon computer code having a first portion that is compiled and a second portion that is uncompiled, and a set of computer-executable instructions. The set of computer-executable instructions can perform a method comprising: receiving a unique identifier from the input device and compiling the second portion of computer code, the compilation resulting in the unique identifier or an indicator of the unique identifier being incorporated into the compiled second portion of computer code.

According to another embodiment of the invention, another computer system is provided. The computer system comprises an input device and a computer-readable medium. The computer-readable medium has stored thereon computer code having a first portion that is compiled and a second portion that is uncompiled and a set of computer-executable instructions. The set of computer-executable instructions can perform a method comprising: receiving a plurality of unique identifiers from the input device, and compiling the second portion of computer code, said compilation resulting in the plurality of unique identifiers or a plurality of respective indicators of the plurality of unique identifiers being incorporated into the compiled second portion of computer code.

According to another embodiment of the invention, a computer-readable medium is provided. The computer-readable medium has stored thereon computer code having a first portion that is compiled and a second portion that is uncompiled, and also has stored thereon computer-executable instructions. The computer-executable instructions can perform a method comprising: seeking a unique identifier, and facilitating a process that results in compilation of the second portion of the code, said compilation resulting in the unique identifier or an indicator of the unique identifier being incorporated into the compiled second portion of the code.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

While the appended claims set forth the features of the invention, one embodiment of the invention may be best understood with reference to the following detailed description and accompanying drawings.

FIG. 1 is a schematic diagram generally illustrating an exemplary computer system usable to implement an embodiment of the invention.

FIG. 2 is a flowchart illustrating various blocks of a data security process according to one embodiment of the present invention.

FIG. 3 is a flowchart illustrating various blocks of a data security process according to another embodiment of the invention.

### DETAILED DESCRIPTION OF THE PREFERRED EMBODIMENTS

Turning to the drawings, wherein like reference numerals refer to like elements, the embodiments of the invention are described hereinafter in the context of a computing environment. Although it is not required for practicing the invention, the invention is described as it is implemented by computer-executable instructions, such as program modules, that are executed by a computing device. Generally, program modules include routines, programs, objects, components, data structures and the like, that perform particular tasks or implement particular abstract data types.

Embodiments of the invention may be implemented in many different computing device configurations. For example, embodiments of the invention may be realized in handheld devices, mobile phones, multiprocessor systems, microprocessor-based or programmable consumer electronics, network PC's, minicomputers, mainframe computers and the like, wearable computing or communications devices, or any other device on which computer-executable code can be run. Embodiments of the invention may also be practiced in distributed computing environments, where tasks are performed by remote processing devices that are linked by a communications network. In a distributed computing environment, program modules may be located in both local and remote memory storage devices.

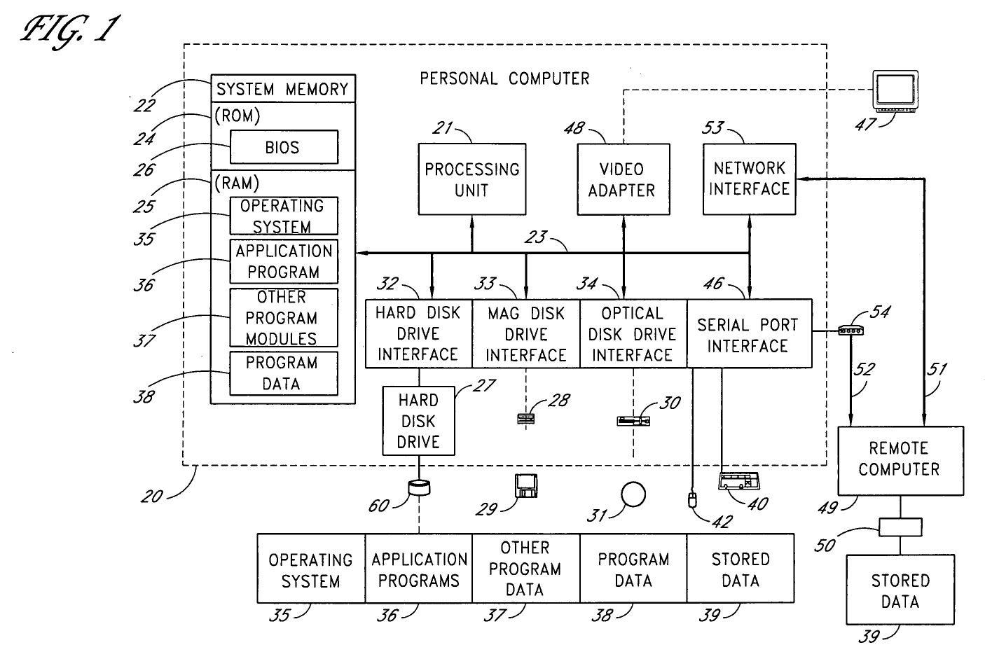

Before describing embodiments of the invention in greater detail, an example computing environment in which a certain embodiment of the invention may operate is described in connection with FIG. 1. A computing device 20 includes a processing unit 21, a system memory 22, and a system bus 23 that couples various system components, including the system memory 22 to the processing unit 21. The system bus 23 may be any of several types of bus structures, including a memory bus or memory controller, a peripheral bus, or a local bus, using any of a variety of bus architectures. The system memory 22 includes read-only memory (ROM) 24 and random access memory (RAM) 25. A basic input/output system (BIOS) 26, containing the basic routines that help to transfer information between elements within the computing device 20, such as during startup, is stored in ROM 24. The illustrated computing device 20 further includes a hard disk drive 27 for reading from, and writing to, a hard disk 60, a magnetic disk drive 28 for reading from, or writing to, a removable magnetic disk 29, and an optical disk drive 30 for reading from, or writing to, a removable optical disk 31, such as a CD-ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the PC. Although the exemplary environment described herein includes a hard disk 60, a removable magnetic disk 29, and a removable optical disk 31, other types of computer-readable media may also be used to store data that is accessible by a computing device, such as, for example, magnetic cassettes, flash memory cards, digital video disks, Bernoulli cartridges, random access memories, read-only memories, combination of the same and the like.

A number of program modules may be stored on the hard disk 60, magnetic disk 29, optical disk 31, ROM 24, or RAM 25, including an operating system 35, one or more applications programs 36, a data encryption program 90, other program modules 37, program data 38, and stored data 39. A user may enter commands and information into the device 20 through input devices such as keyboard 40 and pointing device 42. Other input devices (not shown) may include a microphone, joystick, game pad, satellite dish, scanner, microphone, fingerprint scanner, retinal scanner, or the like. These, and other input devices, are often connected to the processing unit 21 through a serial port interface 46 that is coupled to the system bus, but may be connected by other interfaces, such a parallel port, game port, universal serial bus, firewire, or the like. A monitor 47, or other type of display device, may also typically connect to the system bus 23 via an interface, such as a video adapter 48. In addition to the monitor 47, the computing device 20 typically includes other peripheral output devices (not shown), such as speakers and printers.

The device 20 may be operable in a networked environment using fixed or transient logical connections to one or more remote computing devices, such as a remote computer 49. The remote computer 49 may be another computing device similar to device 20, a server, a router, a network PC, a peer device, or other common network node, a RAID workstation or other information repository, or any other device type such as any of those mentioned elsewhere herein. Often, remote computer 49 may include many or all of the elements described above relative to the computing device 20, although this is not required. Only a memory storage device 50 has been illustrated in FIG. 1, holding only stored data 39. The logical connections depicted in FIG. 1 include a local area network (LAN) 51 and a wide area network (WAN) 52. Such networking environments may be used in offices, enterprise-wide computer networks, intranets, and the Internet, although other logical connections are, of course, possible.

When used in a LAN networking environment, the computing device 20 is connected to the local network 51 through a network interface or adapter 53. When used in a WAN networking environment, the computing device 20 typically includes a modem 54 or other means for establishing communications over the WAN 52. The modem 54, which may be internal or external, is connected to the system bus 23 via the serial port interface 46. Stored data or program modules depicted relative to the computing device 20, or portions thereof, may be stored in the remote memory storage device 50. It will be appreciated that the network connections shown are exemplary, and other means of establishing a communications link between the computers may be used. Additionally, the invention is not intended to be limited to a particular network type. Any network type, wired or wireless, fixed or transient, circuit-switched, packet-switched or other network architectures, may be used to implement embodiments of the invention.

In the description that follows, embodiments of the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computing device or electrical signals representing data in a structured form. This manipulation transforms the data or maintains it at locations in the memory system of the computing device, which reconfigures or otherwise alters the operation of the computing device in a manner well understood by those skilled in the art. The data structures, where data is maintained, are physical locations of memory that have particular properties defined by the format of the data. However, while certain embodiments of the invention are being described in the foregoing context, it is not meant to be limiting, as those of skill in the art will appreciate that various of the acts and operations described hereinafter may also be implemented in hardware.

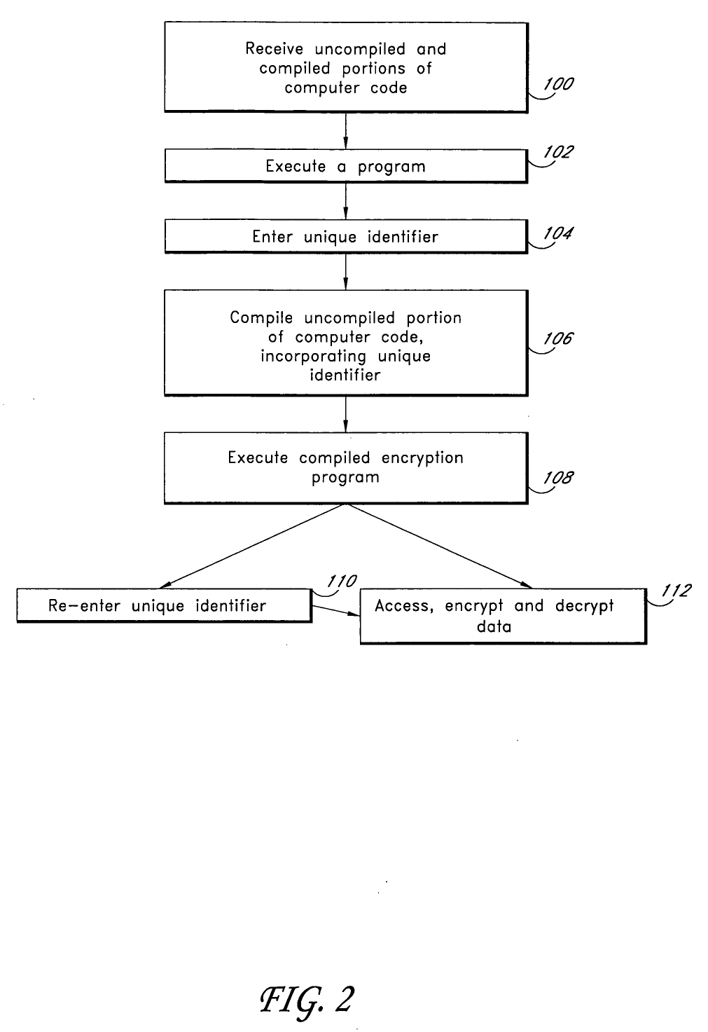

FIG. 2 is a flowchart illustrating various blocks of a data security process according to one embodiment of the invention. At Block 100, a user of a computing device 20 receives uncompiled and compiled portions of computer code. As is well understood by those skilled in the art, uncompiled portions of computer code are not readily executable by a personal computing device, such as device 20. Instead, uncompiled portions of computer code are typically human-readable and may be coded in a variety of computer languages, such as C#, C++, Java, Fortran, Basic, Visual Basic, and other languages used to create computer-executable code. In certain embodiments, these uncompiled portions of computer code may comprise text files containing strictly defined character strings that may eventually be compiled to create computer-executable, compiled code.

Meanwhile, compiled portions of computer code are readily executable by computers, such as device 20.

The term “compile” and variations thereof are broad terms and are used in their ordinary sense and include, without limitation, the translation or converting a higher level programming language to a lower level programming language. For example, “compiling” may comprise translating a source code language into a machine-readable code. In other embodiments, “compiling” may comprise interpreting wherein a particular portion of a computer program is translated and/or executed prior to the translation and/or execution of another portion of the computer program. Furthermore, “compilers” may convert script languages, engage in batch processing, perform real-time translations, combinations of the same or the like.

For example, compiled portions of computer code may comprise a series of binary digits (i.e., “0”s and “1”s) that may be processed by processing unit 21 and that may cause the computing device 20 to perform particular actions according to encoded commands. Compiled portions of computer code are normally smaller than uncompiled portions of computer code and therefore use less memory storage. Of course, other compiled portions of computer code do not merely comprise binary digits and may still require some level of interpretation or compilation before a processing unit 21 can appropriately process their commands. In one example, a second compiler or interpreter program may be executed on the computing device 20 in order to execute the “compiled” portions of computer code.

The differences between uncompiled and compiled portions of computer code need not be so clear-cut. For example, the computer code may comprise Java scripts, such that the compiled portions of the Java scripts may be human-readable, while at the same time remaining computer-executable. Similarly, in other embodiments, the uncompiled portions of computer code may not readily be human-readable, and may comprise binary representations, and/or arcane textual constructs.

The user of the computing device 20 or the computing device 20 itself, may receive the uncompiled and compiled portions of computer code in any of a number of ways. In one embodiment, the uncompiled and compiled portions of computer code may be received over the internet, through the LAN or WAN 52. In a second preferred embodiment, the uncompiled and compiled portions of computer code may be inscribed on a removable optical disk 31, such as a CD ROM and may be read via the optical disk drive 30. In still other embodiments, the uncompiled and compiled portions of computer code may be delivered over any of a number of computer readable media that can be read by the computing device 20.

At Block 102, the user of device 20 executes a program on the computing device 20. Typically, the program comprises an executable file (e.g., having the suffix .exe on a Windows™ computer). On Unix, Linux, Apple or other platforms, other suffixes, or other means for recognizing computer-executable computer code may be used. The program may be executed in a number of ways. For example, in one embodiment, the program is represented by an icon that the user can interact with, for example, by double-clicking. In another embodiment, the user may enter commands in a textbox, causing the operating system 35 to execute the program. In other embodiments, the user may execute the program via voice commands, hand movements, or other means of interacting with the computing device 20 via the input devices coupled thereto.

In certain embodiments, the program executed by the user of computing device 20 comprises at least a portion of the compiled portions of computer code received at the computing device 20. In such an embodiment, the uncompiled and compiled portions of computer code may comprise a stand-alone, independent set of program modules, and a user need not execute a separate program. Of course, in other embodiments, the program may comprise a separate program. In one embodiment, this separate program may be provided by a third-party, or may be bundled with the operating system 35.

At Block 104, the executed program, whether at least a portion of the compiled portions of computer code or a separate program, requests from the user a unique identifier. As is well known to those of skill in the art, the program may also perform a number of other processes that may or may not require interaction with the user. For example, in one embodiment, the program may first copy or create a number of data and/or program structures to the hard disk drive 27 before requesting the unique identifier.

The unique identifier may comprise any of a variety of data structures or information. In certain embodiments, the unique identifier comprises a string of characters entered by the user, as is often used for passwords. The character string entered by the user may have a number of restrictions placed thereon. For example, the user may be required to insert one or more numbers, symbols, or non-letter characters. The user may also be required to enter a string having a particular length in order to make it more difficult for a potential data thief to enter an identical string.

In another embodiment, the unique identifier may be randomly generated by the computing device 20, and may comprise, for example, a generated number or character string. In one embodiment, the number may correspond to time data requested from the computing device, which time data may be measured to the nearest microsecond.

In another embodiment, the unique identifier may correspond to one or more physical characteristics of the user. For example, a retinal scanner connected to the computer may register characteristics of a user's retina, and the executed program may use those characteristics to create a character string or number, which may then comprise the unique identifier. In another embodiment, a fingerprint scanner may be used in a similar manner. Other unique identifiers may also be used and derived in a number of ways, as is well known to those skilled in the art.

In another embodiment, the unique identifier may comprise a plurality of unique identifiers. For example, in one embodiment, one user may enter a first unique identifier, and the program may then prompt a second user to enter a second unique identifier. In this manner, only entry of both unique identifiers may enable access to sensitive information controlled by certain computer code. Other unique identifiers may also be used. For example, in one embodiment, one of the unique identifiers may be a password or character string entered by a user, while the other unique identifier represents a physical characteristic of the user.

At Block 106, after at least one unique identifier has been entered, the uncompiled portion of computer code is compiled, preferably incorporating the unique identifier or identifiers. The unique identifier and uncompiled portion of computer code are thereby transformed into a compiled program, preferably decipherable only by a computer, such as computing device 20. Thus, even the programmer who originally programmed the uncompiled portions of computer code would be unable to decipher the resulting compiled program, in order to access the unique identifier entered by the user.

In other embodiments of the invention, an indicator of the unique identifier is incorporated as the uncompiled portion of computer code is compiled. In such embodiments, the indicator, instead of the unique identifier, is included in the compiled program while the unique identifier itself is stored in another location, such as a hidden and/or remote location in the memory of the computing device. In certain embodiments, the indicator comprises a pointer, a link, an index, or other like information or technique that is usable to identify the location of the unique identifier.

In certain embodiments, the compiled and uncompiled portions of computer code are compiled together with the unique identifier or identifiers to create a compiled program. Thus, in one embodiment, the compiled portion of computer code recompiles itself along with the uncompiled portion of computer code and unique identifier at Block 106.

In certain embodiments, the uncompiled and compiled portions of computer code, when compiled, comprise the data encryption program 90, configured to encrypt stored data. However, in other embodiments, the resulting compiled program may be any of a number of computer programs well known to those of skill in the art. For example, the compiled program may comprise a word processing program, web browser, spreadsheet program, or other computer-related application. These programs may also encrypt associated stored data using the unique identifier entered by the user. In other embodiments, the compiled and uncompiled portions of computer code, when compiled, may comprise an operating system, accessible only via entry of the unique identifier.

As shown in Block 108, in certain embodiments, the encryption program 90 resulting from the compilation of Block 106 may be executed. In one embodiment, the encryption program 90 may be used to encrypt stored data 39, which is stored on the hard disk drive 27 of computing device 20. In another embodiment, the encryption program 90 may be used to encrypt stored data 39 stored on a remote computer 49 and accessed through any of a number of logical connections.

In one embodiment, the encryption program 90 may be used to encrypt pre-existing stored data 39. One example of a means of encrypting data is described at great length in U.S. Pat. No. 6,272,631, issued to Thomlinson et al., which is incorporated herein by reference in its entirety. In another embodiment, the encryption program 90 may be used to encrypt newly entered or received data. In still another embodiment, the encryption program 90 may not encrypt stored data 39, but may instead restrict access to the encryption program 90 itself such that only upon entry of the unique identifier can a user access or run the program.

At Block 110, in one embodiment, once the encryption program 90 has been executed, a user must first enter the unique identifier or identifiers in order to access certain functionality of the encryption program 90. In one embodiment, once the user has entered the unique identifier, the user can preferably both encrypt and decrypt stored data 39, as shown at Block 112. In another embodiment, a user may use the encryption program 90 to encrypt stored data 39 but must enter the unique identifier in order to decrypt it. In still another embodiment, Block 110 may be bypassed, and, at Block 112, any user that has access to the computing device 20, and thereby access to the encryption program 90, may encrypt and decrypt the stored data 39. In such an embodiment, it is preferable that the computing device 20 be accessible only by certain users, or certain classes of users. For example, in one embodiment, the operating system 35 itself may have an associated password, or unique identifier, by which access to the computing device 20 may be limited. In embodiments in which a plurality of unique identifiers are used, may be required that all of the unique identifiers be entered before encrypted stored data 39 can be decrypted. However, in some embodiments, any one of the unique identifiers, when entered, may enable access to the data.

As illustrated in Block 112, the encryption program 90 allows users to access, encrypt, and decrypt stored data 39. As discussed above, a number of methods for encrypting and decrypting computer data may be used, such as those used to encrypt and decrypt data stored in medical or other sensitive databases.

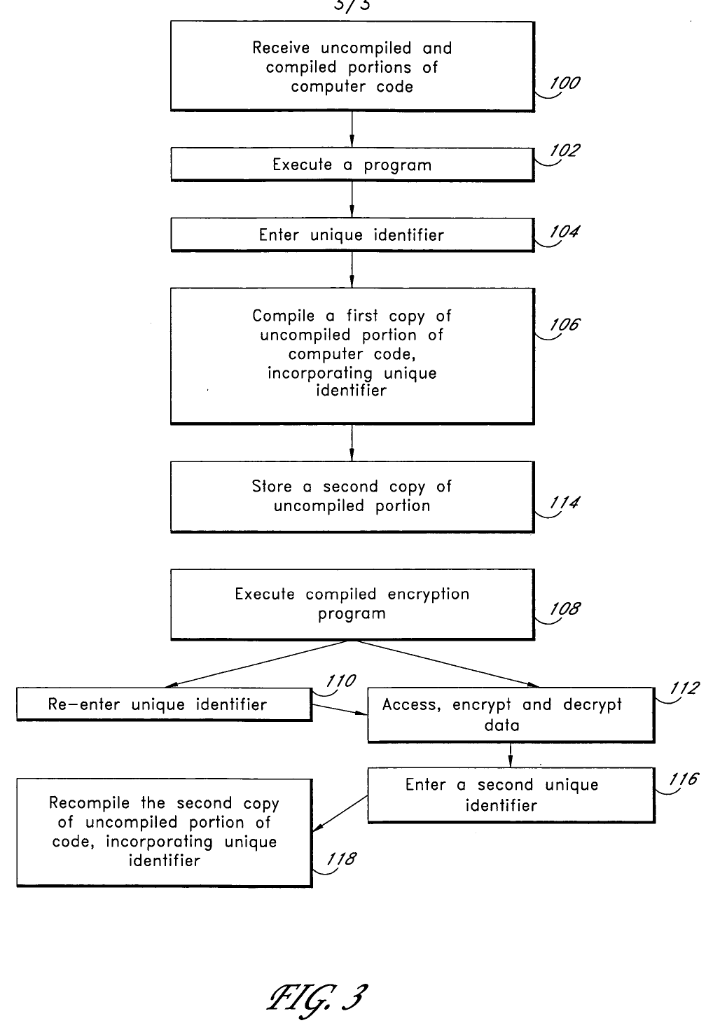

FIG. 3 is a second flowchart illustrating another data security process according to certain embodiments of the invention. Blocks 100, 102, 104, and 106 are substantially identical to those blocks discussed in greater detail above with reference to FIG. 2. However, with respect to Block 106, rather than compiling the uncompiled portion of computer code, the program now compiles a first copy of the uncompiled portion of computer code, leaving at least one other copy uncompiled.

At Block 114, the program stores this second copy of the uncompiled portion of computer code for future use. For example, the second copy of the uncompiled portion of computer code may be stored on a number of different storage media, such as the hard disk drive 27. In another embodiment, the uncompiled portion may remain stored on an optical disk 31. In one embodiment, for example, the uncompiled portion of computer code need not be stored again, but may simply be stored as originally delivered, on a CD-ROM. In this embodiment, the program may not actually store the second copy of the uncompiled portion of computer code, but might simply copy the uncompiled portion of computer code onto the hard disk drive 27 to compile it. Thus, the program would create two copies of the computer code, one on the original CD-ROM and the other on the hard disk drive 27.

Once a copy of the uncompiled portion of computer code is stored on some storage media, Blocks 108, 110, and 112 may occur in a manner similar to that discussed above with reference to FIG. 2. As is well known to those of skill in the art, a user will often find it desirable to change his or her unique identifier at regular intervals in order to make it more difficult for potential data thieves to guess that unique identifier.

According to Block 116, at some point after the first copy of the uncompiled portion of computer code was compiled, the user enters a second unique identifier. In an embodiment, the user may enter some command in the compiled encryption program 90 that causes the compiled encryption program to request a second unique identifier. In another embodiment, the compiled encryption program 90 itself might prompt the user at regular or random intervals to enter a new unique identifier. As discussed above, there may be a number of limitations placed on this unique identifier, and the unique identifier may comprise any of a number of data structures. For example, in one embodiment, the encryption program 90 might not allow a second unique identifier that is identical to the first unique identifier.

At Block 118, once the second unique identifier has been entered, the second copy of the uncompiled portion of computer code may be recompiled, preferably incorporating the second unique identifier or associated indicator, in order to create a recompiled program. In an embodiment, this recompiled program comprises an encryption program 90 that functions substantially identically to the originally compiled program. In another embodiment, the recompiled encryption program 90 automatically encrypts stored data 39 according to a new algorithm incorporating the second unique identifier. Thus, by recompiling the second copy of the uncompiled portion of computer code with the second unique identifier, the algorithm used to encrypt data has been effectively changed without storing the new unique identifier in a human-readable or decipherable form on the computing device 20.

In certain embodiments, the encryption program 90, rather than compiling the second copy of the uncompiled portion of computer, code may create a third copy, which it can manipulate and compile on the hard disk drive 27.

It will be appreciated that a novel means of delivering computer code has been described. In view of the many possible embodiments to which the principles of this invention may be applied, it should be recognized that the embodiments described herein with reference to the drawing figures are meant to be illustrative only and should not be taken as limiting the scope of the invention. Those of skill in the art will recognize that the elements of the illustrated embodiments shown in software may be implemented in hardware and vice versa, or that the illustrated embodiments can be modified in arrangement and detail without departing from the spirit of the invention. For example, although the invention has been described primarily with reference to personal computers and their associated displays and desktops, it should be appreciated that the invention does not require a PC or a traditional desktop, but rather can also be implemented on other devices that can execute computer code. As another example, all of those steps referred to as being executed or initiated by a user may also be initiated or executed independently, or automatically by a computer process or sub-routine. Therefore, the invention as described herein contemplates all such embodiments as may come within the scope of the following claims and equivalents thereof.

What is claimed is:

1. A method of compiling computer code using a unique identifier, the method comprising:
providing computer code having a first portion that is compiled, and a second portion that is uncompiled; and
executing a program that (1) seeks a unique identifier, and, if the unique identifier is present, (2) facilitates a process that results in compilation of the second portion of the code, said compilation resulting in at least one of the unique identifier and an indicator of the unique identifier being incorporated into the compiled second portion of the code.

2. The method of claim 1, wherein the unique identifier comprises an encryption key.

3. The method of claim 1, wherein the program comprises the first portion of the code.

4. The method of claim 1, wherein the first portion of the code comprises the program.

5. The method of claim 1, wherein at least one of the compiled first portion and the compiled second portion of the code is configured to encrypt data.

6. The method of claim 1, wherein at least one of the compiled first portion and the compiled second portion of the code is configured to decrypt data.

7. The method of claim 1, wherein the program comprises a first program, the method further comprising:
executing a second program that (1) seeks a second unique identifier, and, if the second unique identifier is present, (2) facilitates a second process that results in recompilation of the second portion of the code, said recompilation resulting in at least one of the second unique identifier and an indicator of the second unique identifier being incorporated into the recompiled second portion of the code.

8. The method of claim 7, wherein the second program comprises the first program.

9. A method of compiling computer code using a plurality of unique identifiers, the method comprising:
providing computer code having a first portion that is compiled and a second portion that is uncompiled; and
executing a program that (1) seeks the plurality of unique identifiers, and, if each of the plurality of unique identifiers is present, (2) facilitates a process that results in compilation of the second portion of the code, said compilation resulting in at least one of the plurality of unique identifiers and a plurality of respective indicators of the plurality of unique identifiers being incorporated into the compiled second portion of the code.

10. The method of claim 9, wherein the plurality of unique identifiers comprises an encryption key.

11. The method of claim 9, wherein at least one of the compiled first portion and the compiled second portion of the code is configured to encrypt data.

12. The method of claim 9, wherein at least one of the compiled first portion and the compiled second portion of the code is configured to decrypt data.

13. The method of claim 12, wherein the at least one of the compiled first portion and the compiled second portion of the code configured to decrypt data seeks each of the plurality of unique identifiers before decryption.

14. A computer system comprising:
an input device; and
a computer-readable medium having stored thereon:
computer code having a first portion that is compiled and a second portion that is uncompiled; and
a set of computer-executable instructions configured to perform a method comprising: receiving a unique identifier from the input device, and compiling the second portion of computer code, said compilation resulting in at least one of the unique identifier and an indicator of the unique identifier being incorporated into the compiled second portion of computer code.

15. The computer system of claim 14, wherein the unique identifier comprises an encryption key.

16. The computer system of claim 14, wherein the first portion of computer code comprises the set of computer-executable instructions.

17. The computer system of claim 14, wherein the set of computer-executable instructions comprises the first portion of computer code.

18. The computer system of claim 14, wherein at least one of the compiled first portion and the compiled second portion of computer code comprises computer-executable instructions for encrypting data.

19. The computer system of claim 14, wherein at least one of the compiled first portion and the compiled second portion of computer code comprises computer-executable instructions for decrypting data.

20. A computer system comprising:
an input device; and
a computer-readable medium having stored thereon:
computer code having a first portion that is compiled, and a second portion that is uncompiled; and
a set of computer-executable instructions configured to perform a method comprising:
receiving a plurality of unique identifiers from the input device; and
compiling the second portion of computer code, said compilation resulting in at least one of the plurality of unique identifiers and a plurality of respective indicators of the plurality of unique identifiers being incorporated into the compiled second portion of computer code.

21. The computer system of claim 20, wherein the plurality of unique identifiers comprises an encryption key.

22. The computer system of claim 20, wherein at least one of the compiled first portion and the compiled second portion of computer code comprises computer-executable instructions for encrypting data.

23. The computer system of claim 20, wherein at least one of the compiled first portion and the compiled second portion of computer code comprises computer-executable instructions for decrypting data.

24. The computer system of claim 23, wherein the at least one of the compiled first portion and the compiled second portion of computer code comprising computer-executable instructions for decrypting data seeks each of the plurality of unique identifiers before decryption.

25. A computer-readable medium having stored thereon computer code having a first portion that is compiled and a second portion that is uncompiled, and computer-executable instructions configured to perform a method comprising:
seeking a unique identifier; and
facilitating a process that results in compilation of the second portion of the code, said compilation resulting in at least one of the unique identifier and an indicator of the unique identifier being incorporated into the compiled second portion of the code.

26. The computer-readable medium of claim 25, wherein the unique identifier comprises an encryption key.

27. The computer-readable medium of claim 25, wherein the first portion of the code comprises the computer-executable instructions.

28. The computer-readable medium of claim 25, wherein the computer-executable instructions comprise the first portion of the code.

29. The computer-readable medium of claim 25, wherein at least one of the compiled first portion and the compiled second portion of the code comprises computer-executable instructions for encrypting data.

30. The computer-readable medium of claim 25, wherein at least one of the compiled first portion and the compiled second portion of the code comprises computer-executable instructions for decrypting data.

31. The computer-readable medium of claim 25, wherein the method performed by the computer-executable instructions further comprises:
seeking a second unique identifier; and
facilitating a second process that results in recompilation of the second portion of the code, said recompilation resulting in at least one of the second unique identifier and an indicator of the second unique identifier being incorporated into the recompiled second portion of the code.
